(19) United States
(12) Patent Application Publication
(10) Pub. No.: US 2023/0339415 A1
(43) Pub. Date: Oct. 26, 2023

(54) WIRE HARNESS

(71) Applicant: SUMITOMO WIRING SYSTEMS, LTD., Yokkaichi-shi, Mie (JP)

(72) Inventors: Ryuta SAITO, Yokkaichi-shi (JP); Katsutoshi IZAWA, Yokkaichi-shi (JP); Kosuke TANAKA, Yokkaichi-shi (JP)

(73) Assignee: SUMITOMO WIRING SYSTEMS, LTD., Yokkaichi-shi, Mie (JP)

(21) Appl. No.: 18/025,570

(22) PCT Filed: Jul. 29, 2021
(86) PCT No.: PCT/JP2021/028026

§ 371 Date: Mar. 9, 2023

(30) Foreign Application Priority Data
Sep. 16, 2020 (JP) 2020-155433

(51) Int. Cl. B60R 16/02; H02G 3/04

(52) U.S. Cl. CPC B60R 16/0207; H02G 3/04

(57) ABSTRACT

A wire harness including: an electric wire; a first metal tube that covers an outer circumference of the electric wire; a second metal tube that includes a first end covering an outer circumference of the first tube, and a second end that is located opposite to the first end and covers an outer circumference of a drawn-out portion of the electric wire that is drawn out from an end of the first tube, the second tube being fixed to an outer circumferential surface of the first tube; and a protector that is fixed to an inner circumferential surface of the second tube and is configured to protect the drawn-out portion by covering an outer circumference of the drawn-out portion.

### BACKGROUND

The present disclosure relates to a wire harness.

Wire harnesses having electric wires formed by connecting a single-core wire and a twisted wire to each other have been conventionally known as wire harnesses routed in vehicles such as hybrid cars and electric cars (see JP 2017-84547A, for example).

The wire harness disclosed in JP 2017-84547A includes a shielding pipe that covers the outer circumference of the connection portion where the single-core wire and the twisted wire are connected to each other, and a protector that is fixed to the end portion of the shielding pipe and attached to the electric wire. At the connection portion, the single-core wire and the twisted wire overlap each other and are connected through, for example, soldering or welding. Note that the protector is referred to as the “positioning member” in JP 2017-84547A.

The protector includes a tubular portion having a cylindrical shape, a band-shaped attachment piece that protrudes from one end of the tubular portion in the axial direction, and a locking projection that protrudes from the outer circumferential surface of the tubular portion. The tubular portion and the attachment piece are located inside the shielding pipe.

The electric wire is inserted into the tubular portion. The protector is attached to the electric wire by winding tape around the attachment piece and the electric wire inserted into the tubular portion together. The locking projection is configured to be capable of being locked to a locking-target portion provided at an end portion of the shielding pipe. The locking-target portion is a hole that extends through the end portion of the shielding pipe in the thickness direction thereof. The protector is fixed to the end portion of the shielding pipe by locking the locking projection to the locking-target portion.

### SUMMARY

Since the protector is located inside the shielding pipe, the shielding pipe needs to have an inner diameter that is larger than the outer diameter of the protector. In this case, the outer diameter of the shielding pipe may increase as the inner diameter of the shielding pipe is increased. This may lead to an increase in the size of the entire wire harness.

An exemplary aspect of the disclosure provides a wire harness capable of suppressing an increase in the size of the wire harness.

A wire harness according to this disclosure includes: an electric wire; a first metal tube that covers an outer circumference of the electric wire; a second metal tube that includes a first end covering an outer circumference of the first tube, and a second end that is located opposite to the first end and covers an outer circumference of a drawn-out portion of the electric wire that is drawn out from an end of the first tube, the second tube being fixed to an outer circumferential surface of the first tube; and a protector that is fixed to an inner circumferential surface of the second tube and is configured to protect the drawn-out portion by covering an outer circumference of the drawn-out portion, wherein the second tube includes a protrusion that protrudes from the inner circumferential surface of the second tube toward the outer circumferential surface of the first tube, and that engages with the first tube.

With the present disclosure, an increase in the size of a wire harness can be suppressed.

### BRIEF DESCRIPTION OF THE DRAWINGS

FIG. 1 is a schematic configuration diagram showing a wire harness according to an embodiment.

FIG. 2 is a cross-sectional view of a portion A in FIG. 1.

FIG. 3 is an exploded perspective view showing a state where a first tubular member and a protector according to an embodiment are separated from each other.

FIG. 4 is a cross-sectional view showing a wire harness according to a modification example.

### DETAILED DESCRIPTION OF EMBODIMENTS

### Description of Embodiments of the Present Disclosure

First, aspects of the present disclosure will be listed and described.

A wire harness according to this disclosure includes an electric wire member; a first metal tubular member that covers an outer circumference of the electric wire member; a second metal tubular member that includes a first end portion covering an outer circumference of the first tubular member, and a second end portion that is located opposite to the first end portion and covers an outer circumference of a drawn-out portion of the electric wire member that is drawn out from an end portion of the first tubular member, the second tubular member being fixed to an outer circumferential surface of the first tubular member; and a protector that is fixed to an inner circumferential surface of the second tubular member and is configured to protect the drawn-out portion by covering the outer circumference of the drawn-out portion, in which the second tubular member includes a protruding portion that protrudes from the inner circumferential surface of the second tubular member toward the outer circumferential surface of the first tubular member, and that engages with the first tubular member.

With this configuration, the protector covering the outer circumference of the drawn-out portion is fixed to the inner circumferential surface of the second tubular member. Accordingly, compared with a configuration in which the protector is fixed to the inner circumferential surface of the first tubular member, the inner diameter of the first tubular member can be reduced, thus making it possible to reduce the outer diameter of the first tubular member. Therefore, an increase in the size of the wire harness can be suppressed.

Also, with the above configuration, because the second tubular member has the protruding portion that engages with the first tubular member, there is no need to use a dedicated member for fixing the second tubular member to the first tubular member. Therefore, an increase in the number of components in the wire harness can be suppressed.

(2) It is preferable that a portion of the electric wire member covered by the first tubular member is longer than a portion of the electric wire member covered by the second tubular member.

With this configuration, the proportion occupied by the first tubular member in the longitudinal direction of the wire harness is larger than the proportion occupied by the second tubular member. Therefore, an increase in the size of the wire harness is remarkably suppressed by reducing the outer diameter of the first tubular member.

(3) It is preferable that the protruding portion is provided over the entire circumferential direction of the second tubular member.

With this configuration, the protruding portion allows the second tubular member to engage with the first tubular member over the entire circumferential direction thereof. Thus, it is possible to firmly fix the second tubular member to the first tubular member.

(4) It is preferable that the wire harness includes a sealing member that is provided in the end portion of the first tubular member and is configured to stop a liquid from moving between the outer circumferential surface of the electric wire member and an inner circumferential surface of the first tubular member.

With this configuration, it is possible to inhibit water from entering the first tubular member via the end portion of the first tubular member.

(5) It is preferable that the protector faces the sealing member in an axial direction of the first tubular member.

With this configuration, if the sealing member moves toward the protector in the axial direction of the first tubular member, the sealing member comes into contact with a portion of the protector that faces the sealing member. Accordingly, it is possible to inhibit the sealing member from coming loose from the first tubular member. Therefore, it is possible to suppress a decrease in the water stopping performance of the first tubular member.

(6) It is preferable that the protector is in contact with the sealing member in the axial direction of the first tubular member.

With this configuration, it is possible to further inhibit the sealing member from coming loose from the first tubular member. Therefore, it is possible to further suppress a decrease in the water stopping performance of the first tubular member.

(7) It is preferable that the first tubular member includes a protrusion that protrudes from the inner circumferential surface of the first tubular member, and the protrusion is located inward of the sealing member in the axial direction of the first tubular member and faces the sealing member.

With this configuration, if the sealing member moves inward in the axial direction of the first tubular member, the sealing member comes into contact with the protrusion. Accordingly, it is possible to inhibit the sealing member from moving inward in the axial direction. Thus, the sealing member can be positioned.

(8) It is preferable that the electric wire member includes a first electric wire, a second electric wire that is electrically connected to the first electric wire, the first electric wire includes a single-core wire constituted by a single conductor, and an insulating sheath that covers an outer circumference of the single-core wire, the second electric wire includes a twisted wire obtained by twisting a plurality of bare metal wires together, and an insulating sheath that covers an outer circumference of the twisted wire, and a portion in a lengthwise direction of the drawn-out portion is provided with a connection portion where the first electric wire that is drawn out from the end portion of the first tubular member and the second electric wire located outside the first tubular member are electrically connected to each other.

Because the single-core wire and the twisted wire overlap each other at the connection portion, the size of a cross-section of the connection portion may increase. Thus, if the outer circumference of the connection portion is covered by the first tubular member, for example, the inner diameter of the first tubular member needs to be larger than the size of the cross-section of the connection portion.

In this respect, according to the above configuration, the connection portion is provided at a portion of the drawn-out portion in the lengthwise direction thereof. That is, the connection portion is located outside the first tubular member. Thus, even when the cross-section of the connection portion is large, there is no need to increase the inner diameter of the first tubular member. Accordingly, compared with a configuration in which the outer circumference of the connection portion is covered by the first tubular member, the inner diameter of the first tubular member can be reduced, thus making it possible to reduce the outer diameter of the first tubular member. Therefore, an increase in the size of the wire harness can be further suppressed.

(9) It is preferable that an outer circumference of the connection portion is covered by the protector.

With this configuration, it is possible to suppress interference between the connection portion and objects located around the wire harness.

(10) It is preferable that the protector includes a fixing portion to which the drawn-out portion is fixed.

With this configuration, the drawn-out portion is fixed to the fixing portion, thus making it possible to suppress a change in the length of the drawn-out portion that is drawn out from the end portion of the first tubular member.

(11) It is preferable that the protector includes a fixing portion to which the drawn-out portion is fixed, and the fixing portion is provided at a position located farther from the end portion of the first tubular member than a portion of the protector that covers the outer circumference of the connection portion in the lengthwise direction of the drawn-out portion.

With this configuration, a portion of the drawn-out portion that is fixed to the fixing portion is farther from the end portion of the first tubular member than the connection portion is. Accordingly, even when an external force acts on the drawn-out portion, it is possible to suppress the transmission of the external force to the connection portion. Therefore, it is possible to suppress the impairment of the connection reliability of the connection portion.

Also, with the configuration above, the drawn-out portion is fixed to the fixing portion, thus making it easy to control the length of the drawn-out portion that is drawn out from the end portion of the first tubular member.

### Details of Embodiments of the Present Disclosure

Specific examples of a wire harness according to the present disclosure will be described below with reference to the drawings. Portions of configurations may be exaggerated or simplified in the diagrams for convenience in the description. In addition, the ratios between the dimensions shown in the diagrams may be different from each other. Note that the present disclosure is not limited to these examples, and is defined by the claims, and all changes that come within the meaning and range of equivalency of the claims are intended to be embraced therein. The “tubular shape” as used herein need only be a shape that can be considered as a tubular shape as a whole, and encompasses a tubular shape constituted by a combination of components, and a shape provided with a cutout portion such as a C-shape.

### Overall Configuration of Wire Harness 10

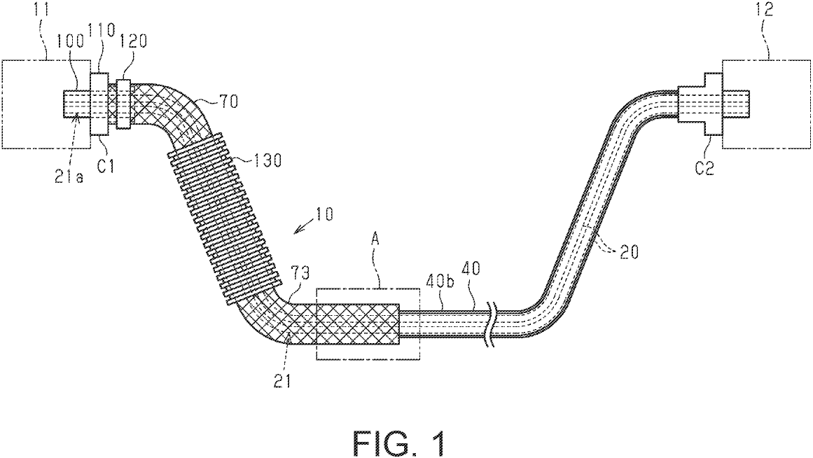

As shown in FIG. 1, a wire harness 10 electrically connects two electrical apparatuses (devices), or three or more electric apparatuses (devices). The wire harness 10 electrically connects an inverter 11 that is provided in a front part of a vehicle, such as a hybrid vehicle or an electric vehicle, and a high-voltage battery 12 that is provided in a part of the vehicle rearward of the inverter 11, for example. An intermediate portion in the lengthwise direction of the wire harness 10 is routed under the floor of the vehicle, for example.

The inverter 11 is connected to a wheel driving motor (not shown), which serves as a power source for driving the vehicle. The inverter 11 generates AC power from DC power that is supplied from the high-voltage battery 12, and supplies the resulting AC power to the motor. The high-voltage battery 12 is a battery that can supply a voltage of several hundred volts, for example.

The wire harness 10 includes one or more electric wire members 20 (electric wire), a first tubular member 40 (first tube) that covers the outer circumference of the electric wire members 20, and a braided wire 70 attached to an outer circumferential surface 40b of the first tubular member 40. The wire harness 10 according to this embodiment includes two electric wire members 20. Each electric wire member 20 may be, for example, a shielded electric wire that includes an electromagnetic shield structure, or a non-shielded electric wire that does not include an electromagnetic shield structure.

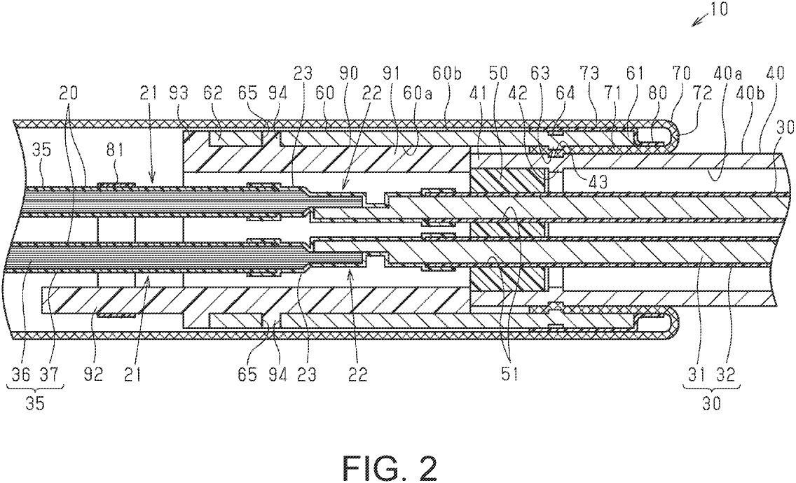

As shown in FIG. 2, the wire harness 10 includes a second tubular member 60 (second tube) that fixes the braided wire 70 to the outer circumferential surface 40b of the first tubular member 40, and a protector 90 that is fixed to an inner circumferential surface 60a of the second tubular member 60.

The outer circumference of the electric wire members 20 is covered by the first tubular member 40 and the second tubular member 60. The portion of the electric wire members 20 covered by the first tubular member 40 is longer than the portion of the electric wire members 20 covered by the second tubular member 60. In this embodiment, the first tubular member 40 is longer than the second tubular member 60.

As shown in FIG. 1, two ends of each electric wire member 20 are respectively attached to a connector C1 and a connector C2. One end of the electric wire member 20 is connected to the inverter 11 via the connector C1. The other end of the electric wire member 20 is connected to the high-voltage battery 12 via the connector C2.

The wire harness 10 includes a housing 100 in which the one end of the electric wire member 20 is housed, a shield shell 110 covering the outer circumference of the housing 100, and a fixing member 120 that fixes the braided wire 70 to an outer surface of the shield shell 110. The housing 100, the shield shell 110, and the fixing member 120 constitute the connector C1.

### Configuration of Electric Wire Member 20

As shown in FIG. 2, each electric wire member 20 includes a first electric wire 30, and a second electric wire 35 electrically connected to the first electric wire 30. The first electric wire 30 is provided in a portion of the wire harness 10 that is to be routed under the floor of the vehicle, for example. The second electric wire 35 is connected to an end of the first electric wire 30.

The electric wire member 20 has a drawn-out portion 21 that is drawn out from an end portion 41 of the first tubular member 40. A connection portion 22 (connection) where an end of the first electric wire 30 and an end of the second electric wire 35 are electrically connected to each other is provided at a portion of the drawn-out portion 21 in the longitudinal direction thereof.

The outer circumference of the connection portion 22 is covered by, for example, an insulating covering member 23 such as a heat-shrinkable tube. Examples of the covering member 23 include a hot-melt adhesive, a resin mold, and a tape member.

### Configuration of First Electric Wire 30

The first electric wire 30 includes, for example, a single-core wire 31 constituted by a single conductor, and an insulating sheath 32 that covers the outer circumference of the single-core wire 31. Examples of the single-core wire 31 include a columnar conductor constituted by a single columnar metal rod having a solid structure, and a tubular conductor having a hollow structure. Examples of the material of the single-core wire 31 include metal materials such as copper-based materials and aluminum-based materials. The single-core wire 31 of this embodiment is made of an aluminum alloy. The single-core wire 31 is formed through, for example, extrusion molding.

The transverse cross-sectional shape of the single-core wire 31 may be any shape. The transverse cross-sectional shape of the single-core wire 31 may be a circular, semicircular, polygonal, square, or flat shape, for example. The transverse cross-sectional shape of the single-core wire 31 in this embodiment is a circular shape. That is, the single-core wire 31 in this embodiment has a round columnar shape.

The insulating sheath 32 covers the entire outer circumferential surface of the single-core wire 31 in the circumferential direction thereof, for example. The insulating sheath 32 is made of an insulating material such as a synthetic resin, for example. It is possible to use, as a main component, a synthetic resin containing a polyolefin-based resin such as crosslinked polyethylene or crosslinked polypropylene as the material of the insulating sheath 32, for example. It is possible to use one material alone or two or more types of materials in combination as the material of the insulating sheath 32. The insulating sheath 32 can be formed through, for example, extrusion molding (extrusion coating) performed on the single-core wire 31.

The single-core wire 31 is exposed from the insulating sheath 32 at an end of the first electric wire 30. The portion of the single-core wire 31 exposed from the insulating sheath 32 is crushed into a flat shape, for example.

### Configuration of Second Electric Wire 35

The second electric wire 35 includes, for example, a twisted wire 36 obtained by twisting a plurality of bare metal wires together, and an insulating sheath 37 that covers the outer circumference of the twisted wire 36. A metallic material such as a copper-based material or an aluminum-based material can be used as the material of the twisted wire 36, for example. The twisted wire 36 of this embodiment is made of an aluminum alloy.

The transverse cross-sectional shape of the twisted wire 36 may be any shape. The transverse cross-sectional shape of the twisted wire 36 may be a circular, semicircular, polygonal, square, or flat shape, for example. The transverse cross-sectional shape of the twisted wire 36 in this embodiment is a circular shape.

The insulating sheath 37 covers the entire outer circumferential surface of the twisted wire 36 in the circumferential direction thereof, for example. The insulating sheath 37 is made of an insulating material such as a synthetic resin, for example. It is possible to use, as a main component, a synthetic resin containing a polyolefin-based resin such as crosslinked polyethylene or crosslinked polypropylene as the material of the insulating sheath 37, for example. It is possible to use one material alone or two or more types of materials as the material of the insulating sheath 37. The insulating sheath 37 can be formed through, for example, extrusion molding (extrusion coating) performed on the single-core wire 36.

The twisted wire 36 is exposed from the insulating sheath 37 at an end of the second electric wire 35. The portion of the twisted wire 36 exposed from the insulating sheath 37 is crushed into a flat shape as a whole, for example.

The portion of the twisted wire 36 exposed from the insulating sheath 37 overlaps with and is joined to the single-core wire 31 exposed from the insulating sheath 32, for example. The single-core wire 31 and the twisted wire 36 are joined together using a known joining method such as ultrasonic joining or resistance welding, for example. The above-described connection portion 22 is formed by joining the twisted wire 36 and the single-core wire 31 together. The above-described covering member 23 is provided extending from the end of the insulating sheath 32 to the end of the insulating sheath 37. Therefore, the outer circumference of the single-core wire 31 exposed from the insulating sheath 32 and the outer circumference of the twisted wire 36 exposed from the insulating sheath 37 are covered by the covering member 23.

### Configuration of First Tubular Member 40

The first tubular member 40 has a cylindrical shape, for example. The first tubular member 40 is bent in a shape extending along the route where the electric wire members 20 are to be routed, for example. The first tubular member 40 extends in the front-rear direction of the vehicle under the floor of the vehicle, for example. The first tubular member 40 covers the outer circumference of the portions of the electric wire members 20 routed under the floor of the vehicle. The first tubular member 40 of this embodiment covers the outer circumference of the first electric wires 30 routed under the floor of the vehicle.

A metallic material such as a copper-based material or an aluminum-based material can be used as the material of the first tubular member 40, for example. The first tubular member 40 of this embodiment is made of an aluminum alloy.

The first tubular member 40 includes a protrusion 42 that protrudes from an inner circumferential surface 40a of the first tubular member 40. The protrusion 42 is provided at a position spaced inwardly away from an opening of the end portion 41 in the axial direction of the first tubular member 40. The protrusion 42 is provided over the entire circumferential direction of the first tubular member 40. Therefore, the cross-sectional area of the portion of the first tubular member 40 where the protrusion 42 is provided is smaller than the cross-sectional area of the other portion of the first tubular member 40. The cross-sectional area of the other portion is substantially constant in the axial direction of the first tubular member 40.

A recessed portion 43 is provided in a portion that corresponds to the protrusion 42 on the outer circumferential surface 40b of the first tubular member 40. The recessed portion 43 is provided over the entire circumferential direction of the first tubular member 40.

As shown in FIG. 1, an end portion opposite to the end portion 41 of the first tubular member 40 is electrically connected to the connector C2 in this embodiment. Note that this end portion may be connected to the connector C2 via a braided wire other than the braided wire 70. In this case, the outer circumference of the braided wire may be covered by an outer cover member such as a grommet, for example.

### Configuration of Sealing Member 50

As shown in FIG. 2, the wire harness 10 includes a sealing member 50 (seal) that stops a liquid from moving between the outer circumferential surface of each electric wire member 20 and the inner circumferential surface 40a of the first tubular member 40. The sealing member 50 in this embodiment stops a liquid from moving between the outer circumferential surfaces of the first electric wires 30 and the inner circumferential surface 40a of the first tubular member 40. The sealing member 50 has a round columnar shape as a whole, for example.

The sealing member 50 is provided in the end portion 41 of the first tubular member 40. The sealing member 50 is located at a portion inside the end portion 41 that is closer to the opening of the end portion 41 than the protrusion 42 is. The sealing member 50 faces the protrusion 42 in the axial direction of the first tubular member 40. A rubber plug can be used as the sealing member 50, for example.

The sealing member 50 has two insertion holes 51 into which the first electric wires 30 are respectively inserted. The sealing member 50 is in intimate contact with the inner circumferential surface 40a of the first tubular member 40 and is in intimate contact with the outer circumferential surface of each first electric wire 30.

### Configuration of Second Tubular Member 60

The second tubular member 60 has a cylindrical shape having an inner diameter that is larger than the outer diameter of the first tubular member 40. The second tubular member 60 is fixed to the outer circumferential surface 40b of the first tubular member 40 in a state where the braided wire 70 is held between the second tubular member 60 and the outer circumferential surface 40b of the first tubular member 40.

A metallic material such as a copper-based material or an aluminum-based material can be used as the material of the second tubular member 60, for example. The second tubular member 60 of this embodiment is made of an aluminum alloy.

The second tubular member 60 includes a first end portion 61, and a second end portion 62 located on the side opposite to the first end portion 61 in the axial direction of the second tubular member 60. The first end portion 61 covers the outer circumference of the first tubular member 40 in a state where the braided wire 70 is held between the first end portion 61 and the outer circumferential surface 40b of the first tubular member 40. The second end portion 62 covers a portion of the outer circumference of the drawn-out portion 21 that is farther from the end portion 41 of the first tubular member 40 than the connection portion 22 is. Therefore, the outer circumference of the connection portion 22 is covered by the second tubular member 60.

The second tubular member 60 includes a protruding portion 63 (protrusion) that protrudes from the inner circumferential surface 60a of the second tubular member 60 toward the outer circumferential surface 40b of the first tubular member 40. The protruding portion 63 is provided at a position spaced inwardly away from the opening of the first end portion 61 in the axial direction of the second tubular member 60. More specifically, the protruding portion 63 is provided at a position that corresponds to the recessed portion 43 of the first tubular member 40. The protruding portion 63 is provided over the entire circumferential direction of the second tubular member 60. The width of the protruding portion 63 is slightly smaller than the width of the recessed portion 43 of the first tubular member 40.

The protruding portion 63 presses the braided wire 70 against the outer circumferential surface 40b of the first tubular member 40. More specifically, the protruding portion 63 presses the braided wire 70 against the inner surface of the recessed portion 43 of the first tubular member 40. Accordingly, the braided wire 70 and the first tubular member 40 are electrically connected to each other.

The protruding portion 63 engages with the recessed portion 43 in a state where the braided wire 70 is held between the protruding portion 63 and the recessed portion 43. As a result of the protruding portion 63 engaging with the recessed portion 43, the second tubular member 60 is fixed to the first tubular member 40.

A recessed portion 64 is provided in a portion that corresponds to the protruding portion 63 on the outer circumferential surface 60b of the second tubular member 60. The recessed portion 64 is provided over the entire circumferential direction of the second tubular member 60.

The protruding portion 63 and the recessed portion 64 in this embodiment can be formed by bringing a jig (not shown) into contact with the outer circumferential surface 60b of the second tubular member 60 while rotating the jig relative to the second tubular member 60 to subject the second tubular member 60 to plastic deformation so as to locally reduce the diameter of the second tubular member 60. Examples of such a plastic deformation method include spinning and swaging. In this embodiment, the protruding portion 63 is formed by performing swaging on the second tubular member 60 while the second tubular member 60 holds the braided wire 70 together with the outer circumferential surface 40b of the first tubular member 40. Accompanying the formation of the protruding portion 63, a portion of the first tubular member 40 that corresponds to the protruding portion 63 is plastically deformed such that the diameter of this portion is reduced. Accordingly, the recessed portion 43 is formed in the outer circumferential surface 40b of the first tubular member 40, and the protrusion 42 is formed on the inner circumferential surface 40a of the first tubular member 40.

The second tubular member 60 has two through holes 65 that extend through the second tubular member 60 in the thickness direction thereof. The through holes 65 are aligned in the radial direction of the second tubular member 60. The through holes 65 are provided in a portion of the second tubular member 60 that covers the outer circumference of the drawn-out portion 21 and is spaced inward from the opening of the second end portion 62 in the axial direction of the second tubular member 60.

### Configuration of Braided Wire 70

The braided wire 70 is obtained by braiding conductive strands into a tubular shape, for example. The braided wire 70 is provided to cover substantially the entire outer circumference of the drawn-out portion 21 in the lengthwise direction of the drawn-out portion 21. A braided wire in which a plurality of metal strands are braided or a braided wire in which metal strands and resin strands are braided in combination with each other may be used as the braided wire 70, for example. A metallic material such as a copper-based material or an aluminum-based material can be used as the material of the metal strands, for example. It is possible to use reinforced fibers with good insulating properties and shear resistance, such as para-aramid fibers, as resin strands, for example. The braided wire 70 in this embodiment is formed by braiding metal strands made of an aluminum alloy into a tubular shape.

The braided wire 70 has a first portion 71 that includes one end of the braided wire 70, a second portion 72 that is continuous with the first portion 71, and a third portion 73 that is continuous with the second portion 72.

The first portion 71 is located between the outer circumferential surface 40b of the first tubular member 40 and the inner circumferential surface 60a of the second tubular member 60. A portion of the first portion 71 is sandwiched between the recessed portion 43 of the first tubular member 40 and the protruding portion 63 of the second tubular member 60. This portion is pressed by the protruding portion 63 against the recessed portion 43, and thus crushed more than the other portion of the first portion 71.

The second portion 72 is drawn out in the opposite direction to the direction in which the drawn-out portion 21 is drawn out from the first end portion 61 of the second tubular member 60, and is folded back to the outer circumferential side of the second tubular member 60.

The third portion 73 extends in the direction in which the drawn-out portion 21 is drawn out. The third portion 73 covers the outer circumference of the second tubular member 60 and the outer circumference of the drawn-out portion 21. That is, the third portion 73 collectively covers the outer circumferences of the plurality of second electric wires 35. An end of the third portion 73 on the opposite side to the second portion 72 is electrically connected to the shield shell 110.

As shown in FIG. 1, a portion of the outer circumference of the third portion 73 in the lengthwise direction thereof is covered by an outer cover member 130. The outer cover member 130 in this embodiment is a corrugated tube that has an accordion structure in which ring-shaped protrusions and ring-shaped recesses are arranged alternatingly in the length direction thereof, for example.

### Configuration of Tape Member 80

As shown in FIG. 2, the wire harness 10 includes a tape member 80 wound around the outer circumferential surface of the first end portion 61 of the second tubular member 60 and the second portion 72 of the braided wire 70.

The tape member 80 has an adhesive layer on one side in the thickness direction thereof. The tape member 80 is wound multiple times around the outer circumferential surface of the first end portion 61 and the second portion 72 with the adhesive layer facing inward. Therefore, an end edge of the first end portion 61 is covered by the tape member 80.

### Configuration of Protector 90

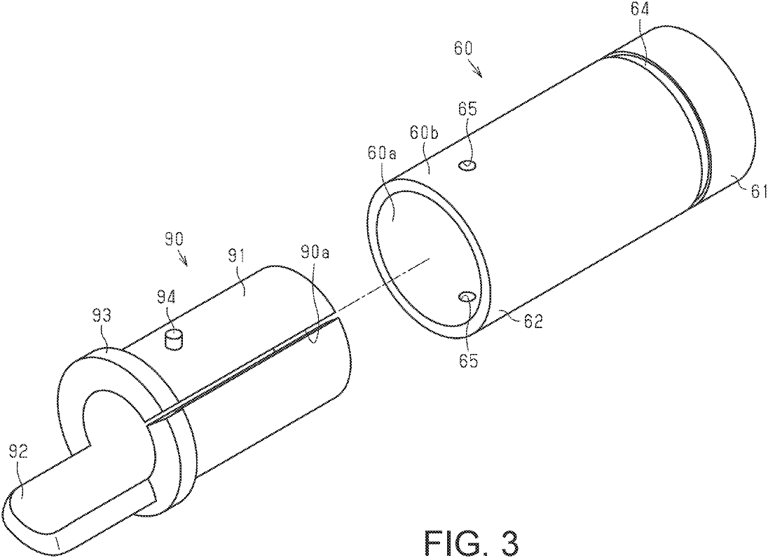

As shown in FIGS. 2 and 3, the protector 90 is fixed to the inner circumferential surface 60a of the second tubular member 60 outside the first tubular member 40. The protector 90 is made of an insulating resin material, for example.

The protector 90 includes a cylindrical insertion portion 91 into which the drawn-out portions 21 are inserted, and a fixing portion 92 that protrudes from one end surface in the axial direction of the insertion portion 91 and to which the drawn-out portions 21 are fixed. Also, the protector 90 includes a ring-shaped flange portion 93 that protrudes from the one end of the insertion portion 91 to the outer circumferential side over the entire circumference thereof, and two engaging protrusions 94 that protrude from the outer circumferential surface of the insertion portion 91 in opposite directions. The engaging protrusions 94 are provided at positions spaced apart from the flange portion 93 in the axial direction of the insertion portion 91.

The protector 90 has a slit 90a that extends along the entire axial direction. The slit 90a extends over the insertion portion 91 and the flange portion 93. The protector 90 is configured to be capable of elastic deformation such that the diameter thereof can be reduced by narrowing the width of the slit 90a.

The insertion portion 91 covers a portion of the outer circumference of the drawn-out portion 21 that includes the connection portion 22. In other words, the outer circumference of the connection portion 22 is covered by the insertion portion 91. A gap is provided over the entire circumference between the inner circumferential surface of the insertion portion 91 and the outer surface of the connection portion 22.

The inner diameter of the insertion portion 91 is smaller than the inner diameter of the first tubular member 40. That is, the insertion portion 91 faces the sealing member 50 in the axial direction of the first tubular member 40. In this embodiment, an inner circumferential portion of the other end surface opposite to the one end surface of the insertion portion 91 is in contact with the sealing member 50 in the axial direction of the first tubular member 40.

The outer diameter of the insertion portion 91 is larger than the outer diameter of the first tubular member 40. Based on the above, the insertion portion 91 is larger than the first tubular member 40. The outer diameter of the insertion portion 91 is substantially the same as the inner diameter of the second tubular member 60.

The fixing portion 92 protrudes in a direction away from the insertion portion 91 in the axial direction of the insertion portion 91. The fixing portion 92 is provided at a position farther from the end portion 41 of the first tubular member 40 than the insertion portion 91 in the lengthwise direction of the drawn-out portion 21. The fixing portion 92 is located outside the second tubular member 60. The fixing portion 92 is provided at a position that is different from that of the slit 90a in the circumferential direction of the insertion portion 91.

The transverse cross-sectional shape of the fixing portion 92 is arc-shaped centered on the axial line of the insertion portion 91, for example. The inner surface of the fixing portion 92 is continuous with the inner circumferential surface of the insertion portion 91 without a step, for example.

The portion of the drawn-out portion 21 located farther from the end portion 41 of the first tubular member 40 than the connection portion 22 is fixed to the fixing portion 92 by a tape member 81. More specifically, the plurality of second electric wires 35 are collectively fixed to the fixing portion 92 by the tape member 81. The tape member 81 is wound multiple times around the fixing portion 92 and the second electric wires 35. Note that the tape member 81 may be of the same type as the above-described tape member 80, or be different from the tape member 80.

The outer diameter of the flange portion 93 is substantially the same as the outer diameter of the second tubular member 60. The flange portion 93 is in contact with the end surface of the second end portion 62 of the second tubular member 60 in the axial direction of the insertion portion 91.

The engaging protrusions 94 are configured to be able to engage with the corresponding through holes 65 of the second tubular member 60. Because the engaging protrusions 94 engage with the through holes 65, the protector 90 is fixed to the inner circumferential surface 60a of the second tubular member 60.

### Configuration of Housing 100

As shown in FIG. 1, the housing 100 has a tubular shape, for example. The end portion 21a of the drawn-out portion 21 is housed in the housing 100. The housing 100 holds the end portion 21a of the drawn-out portion 21. The housing 100 is made of an insulating resin material, for example.

### Configuration of Shield Shell 110

The shield shell 110 covers a portion of the outer circumference of the housing 100, for example. A metallic material such as a copper-based material or an aluminum-based material can be used as the material of the shield shell 110, for example. The shield shell 110 in this embodiment is made of an aluminum alloy. A portion of the outer circumference of the shield shell 110 is covered by the end of the third portion 73 of the braided wire 70.

### Configuration of Fixing Member 120

The fixing member 120 has a ring shape surrounding a portion of the outer surface of the shield shell 110. The fixing member 120 in this embodiment is a crimping ring. A metallic material such as a copper-based material or an aluminum-based material can be used as the material of the fixing member 120, for example. The fixing member 120 of this embodiment is made of an aluminum alloy.

As a result of the fixing member 120 being crimped to the shield shell 110 with the braided wire 70 sandwiched between the fixing member 120 and the outer surface of the shield shell 110, the braided wire 70 is fixed to the outer surface of the shield shell 110. Accordingly, the braided wire 70 and the shield shell 110 are electrically connected to each other.

### Effects of This Embodiment Will Be Described

(1) The wire harness 10 includes the electric wire members 20, the first metal tubular member 40 covering the outer circumference of the electric wire members 20; a second metal tubular member 60 that is fixed to the outer circumferential surface 40b of the first tubular member 40; and the protector 90 that is fixed to the inner circumferential surface 60a of the second tubular member 60 and covers the outer circumference of the drawn-out portion 21. The second tubular member 60 includes the protruding portion 63 that protrudes from the inner circumferential surface 60a of the second tubular member 60 toward the outer circumferential surface 40b of the first tubular member 40, and that engages with the first tubular member 40.

With this configuration, the protector 90 covering the outer circumference of the drawn-out portion 21 is fixed to the inner circumferential surface 60a of the second tubular member 60. Accordingly, compared with a configuration in which the protector 90 is fixed to the inner circumferential surface 40a of the first tubular member 40, the inner diameter of the first tubular member 40 can be reduced, thus making it possible to reduce the outer diameter of the first tubular member 40. Therefore, an increase in the size of the wire harness 10 can be suppressed.

Also, with the above configuration, because the second tubular member 60 has the protruding portion 63 that engages with the first tubular member 40, there is no need to use a dedicated member for fixing the second tubular member 60 to the first tubular member 40. Therefore, an increase in the number of components in the wire harness 10 can be suppressed.

(2) The portion of the electric wire members 20 covered by the first tubular member 40 is longer than the portion of the electric wire members 20 covered by the second tubular member 60.

With this configuration, the proportion occupied by the first tubular member 40 in the lengthwise direction of the wire harness 10 is larger than the proportion occupied by the second tubular member 60. Therefore, an increase in the size of the wire harness 10 is remarkably suppressed by reducing the outer diameter of the first tubular member 40.

(3) The protruding portion 63 is provided over the entire circumferential direction of the second tubular member 60.

With this configuration, the protruding portion 63 allows the second tubular member 60 to engage with the first tubular member 40 over the entire circumferential direction thereof. Thus, it is possible to firmly fix the second tubular member 60 to the first tubular member 40.

(4) The wire harness 10 includes the sealing member 50 that is provided at the end portion 41 of the first tubular member 40 and stops a liquid from moving between the outer circumferential surfaces of the electric wire members 20 and the inner circumferential surface 40a of the first tubular member 40.

With this configuration, it is possible to inhibit water from entering the first tubular member 40 via the end portion 41 of the first tubular member 40.

The protector 90 is in contact with the sealing member 50 in the axial direction of the first tubular member 40.

With this configuration, the sealing member 50 is restricted from moving toward the protector 90 in the axial direction of the first tubular member 40. Accordingly, it is possible to inhibit the sealing member 50 from coming loose from the first tubular member 40. Therefore, it is possible to suppress a decrease in the water stopping performance of the first tubular member 40.

(6) The first tubular member 40 includes a protrusion 42 that protrudes from the inner circumferential surface of the first tubular member 40. The protrusion 42 is located inward of the sealing member 50 in the axial direction of the first tubular member 40, and faces the sealing member 50.

With this configuration, if the sealing member 50 moves inward in the axial direction of the first tubular member 40, the sealing member 50 comes into contact with the protrusion 42. Accordingly, it is possible to inhibit the sealing member 50 from moving inward in the axial direction. Thus, the sealing member 50 can be positioned.

(7) A portion in the lengthwise direction of the drawn-out portion 21 is provided with the connection portion 22 where the single-core wire 31 of the first electric wire 30 that is drawn out from the end portion 41 of the first tubular member 40 and the twisted wire 36 of the second electric wire 35 located outside the first tubular member 40 are electrically connected to each other.

Because the single-core wire 31 and the twisted wire 36 overlap each other at the connection portion 22, the size of the cross-section of the connection portion 22 may increase. Thus, if the outer circumference of the connection portion 22 is covered by the first tubular member 40, for example, the inner diameter of the first tubular member 40 needs to be larger than the size of the cross-section of the connection portion 22.

In this respect, according to the above configuration, the connection portion 22 is provided at a portion in the lengthwise direction of the drawn-out portion 21. That is, the connection portion 22 is located outside the first tubular member 40. Thus, even when the cross-section of the connection portion 22 is large, there is no need to increase the inner diameter of the first tubular member 40. Accordingly, compared with a configuration in which the outer circumference of the connection portion 22 is covered by the first tubular member 40, the inner diameter of the first tubular member 40 can be reduced, thus making it possible to reduce the outer diameter of the first tubular member 40. Therefore, an increase in the size of the wire harness 10 can be suppressed.

(8) The outer circumference of the connection portion 22 is covered by the protector 90.

With this configuration, it is possible to suppress interference between the connection portion 22 and objects to located around the wire harness 10.

(9) The protector 90 includes the insertion portion 91 that covers the outer circumference of the connection portions 22, and the fixing portion 92 that protrudes from the one end surface in the axial direction of the insertion portion 91 and to which the drawn-out portions 21 are fixed. The fixing portion 92 is provided at a position farther from the end portion 41 of the first tubular member 40 than the insertion portion 91 in the lengthwise direction of the drawn-out portions 21.

With this configuration, the portions of the drawn-out portions 21 located farther from the end portion 41 of the first tubular member 40 than the connection portion 22 are fixed to the fixing portion 92. Thus, even when an external force is applied to a drawn-out portion 21, it is possible to suppress the transmission of the external force to the corresponding connection portion 22. Therefore, it is possible to suppress deterioration in the connection reliability of the connection portion 22.

Also, with this configuration, because the drawn-out portions 21 are fixed to the fixing portion 92, the length of the drawn-out portions 21 that are drawn out from the end portion 41 of the first tubular member 40 can be easily controlled.

The drawn-out portions 21 are fixed to the fixing portion 92 by the tape member 81.

According to such a configuration, because the drawn-out portions 21 inserted into the insertion portion 91 are fixed to the fixing portion 92 by the tape member 81, it is possible to use the same protector 90 even when the outer diameter of the electric wire or the number of electric wires in the drawn-out portion 21 changes.

(11) The first tubular member 40 and the second tubular member 60 are made of an aluminum alloy.

According to such a configuration, the first tubular member 40 and the second tubular member 60 are made of a metallic material of the same type. Therefore, it is possible to suppress galvanic corrosion occurring when water enters a space between different metals at the portion where the first tubular member 40 is in contact with the second tubular member 60. Accordingly, there is no need to separately provide an outer cover member that covers the outer circumference of the contact portion in order to inhibit water from entering the contact portion. Therefore, it is possible to suppress an increase in the size of the wire harness 10 and an increase in the number of components in the wire harness 10.

As shown in FIG. 2, the positions of the recessed portion 64 and the protruding portion 63 of the second tubular member 60 in the lengthwise direction can be matched or coincide with each other. In a given example, the depth of the recessed portion 64 and the height of the protruding portion 63 of the second tubular member 60 may match or coincide with each other, and the width of the recessed portion 64 and the lateral width of the protruding portion 63 of the second tubular member 60 may match or coincide with each other. The positions of the recessed portion 43 and the protrusion 42 of the first tubular member 40 in the lengthwise direction can be matched or coincide with each other. In a given example, the depth of the recessed portion 43 and the height of the protrusion 42 of the first tubular member 40 may match or coincide with each other, and the width of the recessed portion 43 and the lateral width of the protrusion 42 of the first tubular member 40 may match or coincide with each other.

As in the example shown in FIG. 2, by forming the recessed portion 64 in the outer circumferential surface of the second tubular member 60 in a state where the first tubular member 40 is inserted into the second tubular member 60 and the first tubular member 40 and the second tubular member 60 partially overlap each other, the protruding portion 63 is formed on the inner circumferential surface of the second tubular member 60, the recessed portion 43 is formed in the outer circumferential surface of the first tubular member 40, and the protrusion 42 is formed on the inner circumferential surface of the first tubular member 40. Therefore, the positions of the recessed portion 64 and the protrusion 63 of the second tubular member 60 and the positions of the recessed portion 43 and the protrusion 42 of the first tubular member 40 in the lengthwise direction can be matched or coincide with each other, and/or the shapes of the recessed portion 64 and the protruding portion 63 of the second tubular member 60 can be matched or coincide with each other and the shapes of the recessed portion 43 and the protrusion 42 of the first tubular member 40 can be matched or coincide with each other.

### Modification Examples

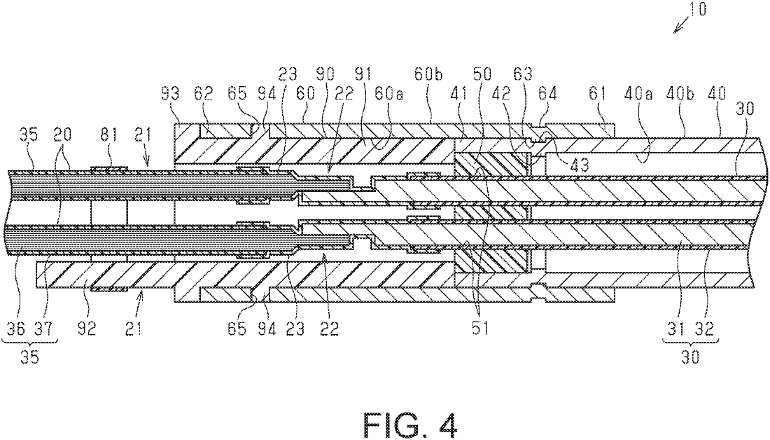

This embodiment can be modified and implemented as follows. This embodiment and the following modification examples may be combined and implemented to the extent that they do not contradict each other technically.
As shown in FIG. 4, the braided wire 70 can be omitted from the wire harness 10. In this case, as a result of the protruding portion 63 engaging with the recessed portion 43, the second tubular member 60 is directly fixed to the outer circumferential surface 40b of the first tubular member 40. In this case, the electric wire member 20 is preferably a non-shielded electric wire that does not include an electromagnetic shield structure. Such a configuration can also exhibit effects corresponding to the above effects (1) to (11).
It is also possible to adopt, as the fixing portion 92, a hole that extends through the insertion portion 91 in the axial direction and holds the outer circumference of the drawn-out portions 21. In this case, the hole may separately hold each electric wire member 20, or collectively hold the plurality of electric wire members 20.
The drawn-out portions 21 can also be fixed to the fixing portion 92 using a resin zip tie, for example, instead of the tape member 81.
The connection portion 22 may also be fixed to the fixing portion 92.
The fixing portion 92 may also be omitted from the protector 90. In this case, the drawn-out portions 21 are not fixed to the protector 90. That is, the protector 90 may simply cover the outer circumference of the drawn-out portions 21.
The insertion portion 91 may also cover a portion of the outer circumference of the drawn-out portion 21 other than the connection portion 22. In other words, the connection portion 22 may be provided in a portion of the drawn-out portion 21 located outside the protector 90.
The electric wire member 20 may be constituted by only the first electric wire 30, or may be constituted by only the second electric wire 35.
The first electric wire 30 may have the twisted wire 36.
The second electric wire 35 may have the single-core wire 31.
The protrusion 42 may be in contact with the sealing member 50 in the axial direction of the first tubular member 40.
The protrusion 42 can also be omitted from the first tubular member 40. In this case, the protruding portion 63 can be set at any position in the axial direction of the second tubular member 60 as long as it is located at a portion where the first portion 71 is located on the inner circumferential side of the second tubular member 60. The protruding portion 63 may be provided at the portion of the second tubular member 60 located on the outer circumference of the sealing member 50. Note that, if the protrusion 42 is omitted from the first tubular member 40, the recessed portion 43 is preferably provided in the portion of the outer circumferential surface 40b of the first tubular member 40 that corresponds to the protruding portion 63.
The insertion portion 91 may be provided at a position distanced from the sealing member 50 in the axial direction of the first tubular member 40. That is, a gap may be provided between the insertion portion 91 and the sealing member 50 in the axial direction of the first tubular member 40. In this case, this gap is preferably smaller than the length in the axial direction of the sealing member 50. With this configuration, if the sealing member 50 moves toward the protector 90 in the axial direction of the first tubular member 40, the sealing member 50 comes into contact with the insertion portion 91. Accordingly, it is possible to inhibit the sealing member 50 from coming loose from the first tubular member 40. Therefore, it is possible to suppress a decrease in the water stopping performance of the first tubular member 40.
The inner diameter of the insertion portion 91 may be the same as the inner diameter of the first tubular member, or may be larger than the inner diameter of the first tubular member 40.
The sealing member 50 can also be omitted.
The tape member 80 can also be omitted.
The protruding portion 63 may be provided at a portion in the circumferential direction of the second tubular member 60. Also, a plurality of protruding portions 63 may be provided at intervals in the circumferential direction of the second tubular member 60.
A plurality of protruding portions 63 may be provided at intervals in the axial direction of the second tubular member 60.
The wire harness 10 may include a plurality of first tubular members 40. Also, the wire harness 10 may include a plurality of second tubular members 60.
A portion of the electric wire members 20 covered by the first tubular member 40 may be shorter than a portion of the electric wire members 20 covered by the second tubular member 60. That is, the first tubular member 40 may be shorter than the second tubular member 60.

1. A wire harness comprising:
an electric wire;
a first metal tube that covers an outer circumference of the electric wire;
a second metal tube that includes a first end covering an outer circumference of the first tube, and a second end that is located opposite to the first end and covers an outer circumference of a drawn-out portion of the electric wire that is drawn out from an end of the first tube, the second tube being fixed to an outer circumferential surface of the first tube; and
a protector that is fixed to an inner circumferential surface of the second tube and is configured to protect the drawn-out portion by covering an outer circumference of the drawn-out portion,
wherein the second tube includes a protrusion that protrudes from the inner circumferential surface of the second tube toward the outer circumferential surface of the first tube, and that engages with the first tube.

2. The wire harness according to claim 1,
wherein a portion of the electric wire covered by the first tube is larger than a portion of the electric wire covered by the second tube.

3. The wire harness according to claim 1,
wherein the protrusion is provided over an entire circumferential direction of the second tube.

4. The wire harness according to claim 1, further comprising
a seal that is provided in the end of the first tube and is configured to stop a liquid from moving between an outer circumferential surface of the electric wire and an inner circumferential surface of the first tube.

5. The wire harness according to claim 4,
wherein the protector faces the seal in an axial direction of the first tube.

6. The wire harness according to claim 5,
wherein the protector is in contact with the seal in the axial direction of the first tube.

7. The wire harness according to claim 4, wherein:
the first tube includes a protrusion that protrudes from the inner circumferential surface of the first tube, and
the protrusion is located inward of the seal in an axial direction of the first tube and faces the seal.

8. The wire harness according to claim 1, wherein:
the electric wire includes a first electric wire and a second electric wire that is electrically connected to the first electric wire,
the first electric wire includes a single-core wire formed by a single conductor, and an insulating sheath that covers an outer circumference of the single-core wire,
the second electric wire includes a twisted wire obtained by twisting a plurality of bare metal wires together, and an insulating sheath that covers an outer circumference of the twisted wire, and
a portion in a lengthwise direction of the drawn-out portion is provided with a connection where the first electric wire that is drawn out from the end portion of the first tube and the second electric wire located outside the first tube are electrically connected to each other.

9. The wire harness according to claim 8,
wherein an outer circumference of the connection is covered by the protector.

10. The wire harness according to claim 1,
wherein the protector includes a fixing portion to which the drawn-out portion is fixed.

11. The wire harness according to claim 9, wherein:
the protector includes a fixing portion to which the drawn-out portion is fixed, and
the fixing portion is provided at a position located farther from the end of the first tube than a portion of the protector that covers the outer circumference of the connection in the lengthwise direction of the drawn-out portion.
